(19) United States
(12) Patent Application Publication
(10) Pub. No.: US 2003/0225227 A1
(43) Pub. Date: Dec. 4, 2003

(54) Process for the manufacture of polyolefins using non-metallocene catalysts

(75) Inventors: Subhasis Talapatra, Gujarat (IN); M. S. Choudhary, Gujarat (IN); G. L. Tembe, Gujarat (IN); A. R. Bandyopadhyay, Gujarat (IN); V. K. Upadhyay, Gujarat (IN); R. C. Jain, Gujarat (IN); M. Ravindranathan, Gujarat (IN)

Correspondence Address: Ladas & Parry, 26 West 61 Street, New York, NY, 10023, US

(73) Assignee: INDIAN PETROCHEMICALS CORPORATION LIMITED

(21) Appl. No.: 10/274,826

(22) Filed: Oct. 21, 2002

(30) Foreign Application Priority Data
May 24, 2002 (IN) 461/MUM/2002

(51) Int. Cl. C08F 4/06

(52) U.S. Cl. 526/172; 526/348.2; 526/346; 526/319

(57) ABSTRACT

The present invention discloses a process for the polymerization of olefins in the presence of a catalyst comprising metal complexes of 2,6-diacetylpyridine bis-imines Preferably, the metal is a trivalent metal is selected from the group consisting of trivalent Fe, Ru, or Cr.

### FIELD OF THE INVENTION

The present invention relates to a process for the polymerization of olefins. In particular, the present invention relates to a process for the polymerization of ethylene and/or unsaturated olefins functional monomers. More particularly, the present invention relates to a process for the polymerization of ethylene and/or unsaturated olefins functional monomers in the presence of a catalyst comprising metal complexes of 2,6-diacetylpyridine bis-imines.

### DESCRIPTION OF PRIOR ART

The use of certain transition metal compounds to polymerize ethylene is well established in the prior art. Over the past few decades the developments in the Ziegler-Natta catalysts having very high activities have been exploited in commercial polymerization processes. Polymerization of the unsaturated olefins has been conducted in solution, slurry and so-called “gas-phase” mode. Commodity polyethylenes are thus produced in different types and grades.

Recently new generation of catalysts consisting of tridentate bis-imine type of ligand-complexes with divalent iron and cobalt have been described as catalysts for the polymerization of ethylene [Bennett, A. M et.al. WO Patent 9962967 (December, 1999), Gibson, V C et al. WO Patent 0020427, Gibson, V C. et al. PCT WO Patent 080304 (February 2000). Gibson, V C. et.al. WO 15, 646, McTavish, S. J et.al. PCT Application WO 01, 23396, Behne, P. D. V. et.al. PCT Application WO 01, 40323 (December 1999)].

However, all prior art processes known to the applicants for polymerization of ethylene using non-metallocene type complexes suffer from several drawbacks. Some of the main claims of the prior art processes are use of divalent metal catalysts, higher ratios of co catalysts to active metal ions, higher pressures of ethylene and polyethylene product ranges from low to high density.

### OBJECTS OF THE INVENTION

Accordingly, it is a primary object of the present invention to provide a process for the polymerization of olefins, which overcomes the disadvantages of the prior art.

It is another object of the present invention to provide a process for the polymerization of olefins, which avoids use of divalent metal catalysts without any loss of productivity.

It is yet another object of the present invention to provide a process for the polymerization of olefins, which employs a much lower ratio of co catalysts to active metal ions.

It is yet another object of the present invention to provide reaction conditions for producing ultrahigh density polyethylene as compared to the prior art.

It is yet another object of the present invention to provide a process for the polymerization of ethylene and/or unsaturated olefins functional monomers at a much lower pressure of ethylene and/or unsaturated olefins functional monomers as compared to the prior art.

It is still another object of the present invention to provide a process for the polymerization of ethylene and/or unsaturated olefins functional monomers at lower ratios of catalyst to co-catalysts and essentially at mild operating conditions.

### SUMMARY OF THE INVENTION

The above and further objects of present invention are achieved by polymerization of ethylene and/or propylene, higher o-olefin or methyl acrylate monomer in the presence of a catalyst complex of a trivalent metal with bis-2,6 diacetyl pyridine imines at room temperature. The process is carried out in the presence of an inert aliphatic or aromatic solvent.

The catalyst of the present invention has the general formula I

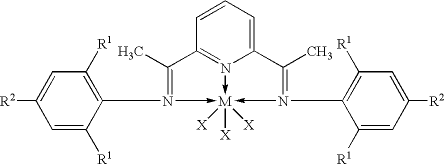

wherein M is a trivalent metal selected from Group IVB to Group VIII elements in the Periodic Table, X is a halide; R¹ and R² are each independently hydrogen, alkyl or aryl group.

Accordingly, the present invention relates to a process for the polymerisation of one or more olefinic monomers which comprises contacted said one or more olefinic monomers with a catalyst consisting of a transition metal compound of the formula

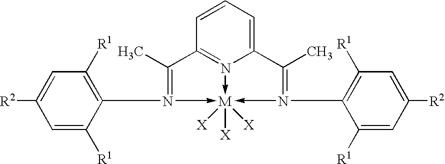

wherein M is a trivalent metal selected from Group IVB to Group VIII elements in the Periodic Table, X is a halide; R¹ and R² are each independently hydrogen, alkyl or aryl group, in presence of a co-catalyst such that the catalyst to co-catalyst molar ratios are maintained between 15 to 200, at a temperature of 20° C. to about 70° C. and olefin pressure of about 1 kg/cm² to about 10 kg/cm².

In a preferred embodiment, said one or more olefinic monomer is selected from one or more of ethylene, propylene an alpha-olefin or a polar co-monomer of the formula H₂C═CH—CO₂CH₃.

Preferably, the trivalent metal is from Group VIII and more preferably is selected from the group, consisting of trivalent Fe, Ru, or Cr.

In a most preferred embodiment, M is trivalent Fe. The co-catalyst is preferably selected from the group consisting of methylaluminoxane, tri-isobutyl aluminoxane, tri n-octyl aluminium and triethylaluminium. In a further preferred embodiment, the ratio of methyl to said trivalent metal is 15 to 200.

In another preferred embodiment, R¹ is H, methyl, or isopropyl and R² is methyl or tert butyl.

Preferably, the polymerisation is carried out at a temperature in the range of from 20° C. to 70° C., for a duration of from 10 to 1-80 min. It is also advantageous to maintain ethylene pressure in the range of 1 kg/cm² to 10 kg/cm.

The monomers may preferably be propylene, 1-octene, styrene or methyl acrylate. The preferred solvent for the reaction is hexane or toluene

### DETAILED DESCRIPTION OF THE INVENTION

The catalyst composition and olefin polymerization and co-polymerization described herein contain certain groups.

By catalyst composition is meant a transition metal salt chosen from Group IVB to Group VIII, more specially that of trivalent first row transition metal ions, which is combined with a suitable tridentate organic compound termed as ligand. This is reacted with olefins to obtain polymer in varying yields.

The polymers produced by the above-described process may vary in their molecular weight, density, molecular weight distribution, melting point. For co-polymers containing ethylene and one other co-monomer the polymer may differ in ratios of co-monomers resulting in improved properties.

The catalysts of the present invention may ideally be prepared as follows:

The catalyst for the polymerization is a transition metal complex of Schiff bases. The transition metal is chosen from Group IVB to Group VIII elements in the periodic table, more suitably from the Group VIII elements. The complexes are prepared by two step process i.e., the first step is the synthesis of Schiff base from aromatic/alkphatic primary amine and a carbonyl derivative of a pyridine compound, preferably, 2,6-diacetyl pyridine. The aromatic primary amines are chosen from among aniline, 2,6-disubstituted derivatives of aniline. The aliphatic amines are chosen from iso-propyl amine, tert-butyl amine, lauryl amine. The reaction is carried out with either with neat, high purity reactants, or in solvents. The solvent is chosen from among ethanol, N-butyanol, n-hexane, nitrobenzene, tetrahydrofuran, diethyl ether, acetonitrile, dicholorobenzene and trichlorobenzene. The acid catalyzed synthesis of Schiff bases is done by refluxing the diketone and the amines in 1:2 ratio for 6-10 hours. The art in the polymerization catalysts need bulky groups around the metal centre and thus the time of reflux will depend on the bulkiness of the Schiff base component. The metal complexes are prepared from the Schiff's base by reacting them with the corresponding metal halides in solvents as mentioned above. The metal salts may have the character in hydrated or anhydrous forms. The catalysts so prepared are used in olefin polymerizations.

The examples that follow illustrate without limiting the scope thereof the methods of making the catalyst composition and its use as catalyst for polymerization process.

### EXAMPLE 1

3.1 mmol. of 2,6-diacetylpyridine was reacted with 9.5 mmol. of 2,6-dimethylanilone in n-butanol at a temperature between 110°-118° C. for 10-12 hours. The bisimine product thus formed was isolated and reacted further with 0.99 mmol. anhydrous FeCl₃ in acetonitrile for 8-10 hours at the temperature between 72°-82° C. The corresponding bisimine complex of Fe(III) chloride was isolated, washed with ether and preserved in vacuum for two days and then stored in drybox.

### EXAMPLE 2

3.1 mmol. of 2,6-diacetylpyridine was reacted with 9.5 mmol. of 2,6-dimethylanilone in n-butanol at a temperature between 110°-118° C. for 10-12 hours. The bisimine product thus formed was isolated and reacted further with 0.99 mmol. anhydrous FeCl₃ in n-butanol for further 8-10 hours at the temperature between 110°-118° C. The corresponding bisimine complex of Fe(III) chloride was isolated, washed with ether and preserved in vacuum for two days and then stored in drybox.

### EXAMPLE 3

3.1 mmol. of 2,6-diacetylpyridine was reacted with 9.5 mmol. of 2,6-dimethylanilone in n-butanol at a temperature between 110°-118° C. for 10-12 hours. The bisimine product thus formed was isolated and reacted further with 0.99 mmol. anhydrous FeCl₃ in 1,2-dichloro benzene for 8-10 hours at the temperature between 140°-150° C. The corresponding bisimine complex of Fe(III) chloride was isolated, washed with ether and preserved in vacuum for two days and then stored in drybox.

### EXAMPLE 4

3.1 mmol. of 2,6-diacetylpyridine was reacted with 9.5 mmol. of 2,6-dimethylanilone in n-butanol at a temperature between 110°-118° C. for 10-12 hours. The bisimine product thus formed was isolated and reacted further with 0.99 mmol. anhydrous FeCl₃ in tetrahydrofuran at 65°-67° C. for 8-10 hours. The corresponding bisimine complex of Fe(III) chloride was isolated, washed and preserved in vacuum for two days and then stored in drybox.

### EXAMPLE 5

1.5 mmol of 2,6-diacetyl pyridine was reacted with 4.8 mmol of 2,6-diisopropylanline in n-butanol at a temperature 117°-118° C. for 10-12 hours and the corresponding imine product was isolated. This product was then treated with 0.5 mmol of anhydrous FeCl₃ in acetonitrile at 80° C. for another 8-10 hours at the same temperature. The corresponding bisimine complex of Fe(III) chloride was isolated, washed with ether and then preserved in vacuum for two days and stored in drybox.

### EXAMPLE 6

1.5 mmol of 2,6-diacetyl pyridine was reacted with 4.8 mmol of 2,4,6-tripheylanline in n-butanol at a temperature 117-118° C. for 10-12 hours and the corresponding imine product was isolated. This product was then treated with 0.5 mmol of anhydrous FeCl₃ in acetonitrile at 80° C. for another 8-10 hours at the same temperature. The corresponding bisimine complex of Fe(III) chloride was isolated, washed with ether and then preserved in vacuum for two days and stored in drybox.

### EXAMPLE 7

1.5 mmol of 2,6-diacetyl pyridine was reacted with 4.8 mmol of tert-butyl amine in n-butanol at a temperature 117°-118° C. for 10-12 hours and the corresponding imine product was isolated. This product was then treated with 0.5 mmol of anhydrous FeCl₃ in acetonitrile at 80° C. for another 8-10 hours at the same temperature. The corresponding bisimine complex of Fe(III) chloride was isolated, washed with ether and then preserved in vacuum for two days and stored in drybox.

### EXAMPLE 8

0.15 mmol. 2,6-diacetyl-2,4,6 tritertiarybutylimine and 0.15 mmol Ruthenium(III) chloride were reacted in dry ethanol to prepare the corresponding Schiff base complex. The contents were initially stirred under an inert atmosphere at 26° C. for one hour and subsequently refluxed for 5 hr. Dark coloured complex was isolated after filtering and drying of the precipitated metal complex. The yield of the isolated complex was 0.08 g.

### EXAMPLE 9

0.15 mmol of anhydrous chromium(III) chloride was reacted with the Schiff base (0.15 mmol) as named in Example 6, in the same reaction conditions as mentioned thereof. The yield of the isolated complex was 0.065 g.

### EXAMPLE 10

Polymerisation of ethylene

Polymerization was carried out in a high pressure batch reactor of 5-liter capacity. The iron (III) catalyst prepared from 2,6 diacetyl pyridine bis(2,6 dimethyl phenylimine) and FeCl₃ as described in Example 1 above (0.06 mmole) was charged into the SS reactor profiled with 2500 ml of dry hexane. Co-catalyst MAO (6 mmole) was taken into the vessel through a charging device under a supply of high purity nitrogen. Ethylene was continuously fed at a pressure of 5 Kg/Cm² for a period of 1 hr. The Al/Fe molar ratio was maintained at 100. The reaction temperature was kept constant at 50° C. The reaction was quenched by rapid cooling and depressurizing the reactor and the resulting polymer drained through the reactor outlet, was filtered and washed with acidified methanol (5% HCl) to yield upon drying 372 gm of polyethylene with a productivity of 11.6 Kg PE/g Cat/hr and a density of 0.993 gm/cm³. Mw=74,600, Mn=4820, MFI=2.01, PDI=15.5, Tm=132.1° C.

### EXAMPLE 11

Polymerization of ethylene by a tridentate complex of Fe was carried out in a 5.0 liter batch reactor as described in Example 10 using a mixed hexane solvent containing about 33% n-hexane and other saturated C₆ components. Ethylene was fed at a low pressure of 3 Kg/Cm² to the reactor. The Al/Fe molar ratio was 120. Total polymer collected was 358 gm. Mw=77800, Mn=4600, PDI-16.8, FMI=1.27 gms/10 min (190° C./2.16 Kg). Tm=131.4° C., d=0.981 g/cm³. The catalyst activity was found to be 13.6 Kg PE/g of cat/hr.

### EXAMPLE 12

Polymerization of ethylene was carried out using the Fe(III) catalyst described in example 10 at an Al/Fe ratio of 200 and a continuous supply of ethylene of 5 Kg/Cm² to the reactor. The reaction was quenched after 30 min. to give 276 gms of polyethylene. Productivity 17.2 Kg PE/g cat/hr. d=0.963 gm/cm³, Mw=92,100 Mn=4600, PDI=20 MFI=2.3 Tm=134° C.

### EXAMPLE 13

Ethylene was polymerized in the 5 litre batch reactor at 5 Kg/Cm² using the Fe(III) catalyst described in example 10, employing Al/Fe molar ratio of 200. The total polymer yield was 316 g. and the productivity 33 Kg PE/gcat/hr. d=0.978 gm Cm3, Mw=84,800 Mn=7400,PDI=11.5, MFI=1.56, Tm=131° C.

### EXAMPLE 14

In a 5.0 litre batch reactor ethylene was polymerized under a continuous supply of ethylene at 10 kg/cm² as described in example 10. The catalyst to co-catalyst molar ratio was kept at 55. The reaction temperature was 70° C. After 1 hr, 341 g. of polymer was obtained with a productivity of 11.7 kg PE/g cat/hr. Tm=132.3° C.

### EXAMPLE 15

Polymerization of ethylene was carried out at low Al/Fe molar ratio of 15 with methylalumoxane as co-catalyst at 40° C. and 1 atmosphere of ethylene in dry hexane solvent (150 ml). The 2,6 diacetyl pyridine bis(2,6-trimethyl phenyl imine) Fe(III) catalyst (1.75 mg, 0.0033 mmol) was taken in a 3 necked flask and purged with nitrogen. The co-catalyst (0.05 mmol) was added to it and aged for 15 mins. After ageing, toluene pre-saturated with ethylene was charged in to the flask. The polymerization was carried out for a period of 30 minutes and solid polyethylene powder, 14.8 g., was recovered. Productivity 1.7 Kg PE/g.cat./hr. Mw=87,600, Mn=2500, PDI=9.2.

### EXAMPLE 16

The polymerization of ethylene was carried out exactly in a manner similar to the one described in example 10. However, in this case the Al/Fe ratio was kept at 30. Productivity=4.0 Kg PE/g.cat/hr. Mw=78,600, Mn=8500, PDI=9.2

### EXAMPLE 17.

Ethylene was polymerized as described in example 10, using the Fe(III) catalyst and keeping the catalyst to co-catalyst ratio at 40. The total productivity of polyethylene was 4.8 Kg PE/g.cat/hr. Mw=77,200, Mn=7600, PDI=10.1

### EXAMPLE 18.

Ethylene was polymerized at 40° C. and/atmosphere pressure using Fe(III) catalyst as described in example 10. The Al/Fe ratio was maintained at 80. The polyethylene obtained at the end of 1 hr reaction was 20.8 g. with productivity 6.4 kg PE/g.cat/hr. Mw=60,800, Mn=2650, PDI=22.9.

### EXAMPLE 19

Ethylene was copolymerized with norbornene as co-monomer and MAO as cocatalyst in toluene at 1 atmosphere and 40° C. using 2,6 diacetyl pyridine-(2,4,6-trimethylphenyl imine)-FeCl₃ as catalyst (4.57 mg, 0.0086 mmole). The ethylene-norbornene copolymer recovered weighed 10.3 g. The catalyst: co-catalyst molar ratio was 30. Productivity=2.2 Kg PE/g.cat/hr. Mw=71300, Mn=4295, PDI=16.6

### EXAMPLE 20

Ethylene was co-polymerized with styrene using reaction conditions mentioned in example 19 to yield 13.9 gm of copolymer with Mw=72500 Mn=4300, PDI=21.3 and Tm=133° C. The catalyst efficiency was 4.2 kg copolymer/g. cat/hr.

### EXAMPLE 21

Ethylene was co-polymerized with 1-octene using reaction conditions mentioned in example 19 to yield 12.2 gm of copolymer with Mw=67,400, Mn=3800, PDI=17.7 and Tm=131° C.

The catalyst efficiency was 3.9 kg copolymer/g cat/hr.

### EXAMPLE 22

Ethylene was co-polymerized with propylene using reaction conditions as mentioned in examples 19 that the Al/Fe molar ratio was kept at 200 to yield 10.4 g. ethylene-propylene copolymer having Mw=58,400, Mn=760, and Tm=127.8° C. The catalyst efficiency was 2.0 kg copolymer/g.cat/hr.

### EXAMPLE 23

Ethylene was copolymerized with methylacrylate using Fe(III) catalyst described in example 10. The Al/Fe molar ratio was 75. The productivity of co-polymer was 0.2 kg/g.cat/hr.

### EXAMPLE 24

Ethylene was polymerized at 40° C. and 1 atmosphere pressure using Ru(III) catalyst (example 8) as per details given in example 15. The Al/Ru molar ratio was maintained at 200. The productivity of polyethylene was 0.08 kgPE/g.cat/hr.

### EXAMPLE 25

Ethylene was polymerized as described in example 24, using the Cr(III) catalyst (example 9) and keeping the Al/Cr molar ratio 200. The polyethylene productivity at the end of 1 hr. reaction was 0.12 kgPE/g. cat/hr.

1. A process for the polymerisation of one or more olefinic monomers which comprises contacting said one or more olefinic monomers with a catalyst consisting of a transition metal compound of the formula 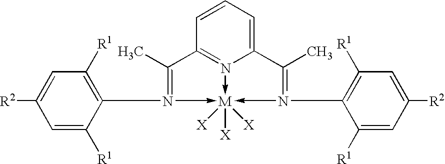
wherein M is a trivalent metal selected from Group IVB to Group VIII elements in the Periodic Table, X is a halide; R¹ and R² are each independently hydrogen, alkyl or aryl group, in presence of a co-catalyst such that the catalyst to co-catalyst molar ratios are maintained between 15 to 200, at a temperature of 20° C. to about 70° C. and olefin pressure of about 1 kg/cm² to about 10 kg/cm².

2. A process as claimed in claim 1 wherein said one or more olefinic monomer is selected from one or more of ethylene, propylene an alpha-olefin or a polar co-monomer of the formula H₂C═CH—CO₂CH₃.

3. A process as claimed in claim 1 wherein the trivalent metal is selected from the group consisting of trivalent Fe, Ru, or Cr.

4. A process as claimed in claim 1 wherein said cocatalyst is selected from the group consisting of methylaluminoxane, tri-isobutyl aluminoxane, tri n-octyl aluminium and triethylaluminium.

5. A process as claimed in claim 1 wherein the ratio of methyl to said trivalent metal is 15 to 200.

6. A process as claimed in claim 1 wherein the density of polyethylene is in the range of 0.963 gm/cm³ to 0.995 gm/cm³.

7. A process as claimed in claim 1 wherein R¹ is H, methyl, or isopropyl and R² is methyl or tert butyl.

8. A process as claimed in claim 1 wherein said polymerisation is carried out at a temperature in the range of from 20° C. to 70° C., for a duration of from 10 to 180 min.

9. A process as claimed in claim 1 wherein the olefin pressure is in the range of 1 kg/cm² to 10 kg/cm².

10. A process as claimed in any preceding claim wherein said one or olefinic monomer is selected from propylene, 1-octene, styrene or methyl acrylate. The preferred solvent for the reaction is hexane or toluene.
